(19) United States
(12) Patent Application Publication
(10) Pub. No.: US 2025/0306665 A1
(43) Pub. Date: Oct. 2, 2025

(54) POWER MANAGEMENT ENGINE IN A SEMICONDUCTOR SYSTEM

(71) Applicant: Microsoft Technology Licensing, LLC, Redmond, WA (US)

(72) Inventors: Basavaraj KANTHI, Karnataka (IN); Sanjeev S. Jahagirdar, Folsom, CA (US)

(21) Appl. No.: 18/622,533

(22) Filed: Mar. 29, 2024

(51) Int. Cl. G06F 1/324; G06F 1/10; G06F 1/28

(52) U.S. Cl. CPC G06F 1/324; G06F 1/10; G06F 1/28

(57) ABSTRACT

Methods, systems, and devices for providing power management using a power management engine of a semiconductor system are described. Power management can refer to power management techniques associated with a semiconductor component (e.g., chiplet). The power management engine supports monitoring power usage and dynamically adjusting power-related parameters to meet a chiplet's performance requirements. In particular, the power management engine supports asynchronous voltage droop detection among chiplets in an integrated circuit, where asynchronous detection denotes that droop events are detected at different times or rates by individual chiplets, without being synchronized. In operation, voltage levels associated with a shared power supply of the first chiplet and a second chiplet are monitored at a first droop detector of a first chiplet. A first voltage droop that triggers a first clock modulation enable signal is detected. The first clock modulation enable signal is communicated to the second chiplet having a second droop detector.

### BACKGROUND

Users rely on electronic devices (e.g., computing devices with applications and services) to perform different types of tasks. Computing devices, and other types of electronic devices, can include semiconductor components or semiconductor systems that perform specific functions within an integrated circuit (IC) or system-on-chip (SoC). For example, a Graphics Processing Unit (GPU) can incorporate chiplets for high computational throughput and memory bandwidth. Semiconductors employ power management systems to provide optimal performance, reliability, and energy efficiency in a wide range of applications. Effective power management strategies can enhance functionality, longevity, and sustainability of devices with semiconductors.

### SUMMARY

Various aspects of the technology described herein are generally directed to systems, methods, and devices for, among other things, providing power management using a power management engine of a semiconductor system. Power management can refer to power management techniques associated with a semiconductor component (e.g., chiplet), where the techniques and mechanisms are employed to regulate and optimize power consumption. The power management engine supports monitoring power usage, detecting changes in operating conditions, and dynamically adjusting power-related parameters to meet a chiplet's performance requirements. In particular, the power management engine supports asynchronous voltage droop detection among chiplets in an integrated circuit, where asynchronous detection denotes that droop events are detected at different times or rates by individual chiplets, without being synchronized or aligned with each other.

A semiconductor system can refer to a 3D integrated circuit package (“3D-IC package”). The 3D-IC package is a type of semiconductor packaging technology that enables stacking of multiple integrated (IC) dies or chiplets vertically within a single package. Vertical integration of ICs result in higher performance and increased functionality, and reduced form factor. In a 3D-IC package, compute chiplets (“chiplets”) can be configured to share a power supply. The chiplets are associated with a power management mechanism or engine to mitigate voltage droops.

Conventional power management systems are not configured with logic and infrastructure for efficient dynamic power management for chiplets. For example, power management techniques simply limit voltage droop sensing and clock modulation to a single chiplet. Power management techniques do not include shared clock modulation or shared sensing for droop modulation. In a 3D-IC package having multiple chiplets, chiplets may have varying impedance characteristics, such that differential droop responses can occur due to the disparity in impedance levels. The impedance mismatch results in different voltage droop behaviors among chiplets during transient load conditions. For example, while operating, a first chiplet from a chiplet set can experience a voltage droop faster than the other chiplets in the chiplet set. In particular, a chiplet with worse impedance will observe higher and quicker droop compared to a chiplet with a better impedance. As such, a power management solution can be developed to account for the worst case droop scenario among chiplets in the chiplet set.

A technical solution—to the limitations of conventional electronic mail systems—can include providing power management resources via a power management system that supports power management in a semiconductor system. The power management resources can include operations for monitoring voltage levels at multiple chiplets of an integrated circuits and using a clock modulation enable signal of a first chiplet to control clock modulation on a second chiplet. The second chiplet may also detect the voltage droop and generate a second clock modulation enable signal; however, bypass modes exist at each of the chiplets to bypass the second clock modulation signal. In this way, the power management engine includes multiple chiplets having corresponding droop detectors; however, only one droop detector is used for controlling clock modulation for the chiplets. As such, the power management system and power management resources can identify a droop detector with superior performance metrics (e.g., response time, noise filtering, error margins) so that the identified droop detector is used to send clock modulation enable signals for chiplets in the semiconductor system.

In operation, voltage levels associated with a shared power supply of the first chiplet and a second chiplet are monitored at a first droop detector of a first chiplet. A first voltage droop that triggers a first clock modulation enable signal is detected. The first clock modulation enable signal is communicated to the second chiplet having a second droop detector.

In a second embodiment, voltage levels associated with a shared power supply of the first chiplet and a second chiplet are independently monitored at a first droop detector of a first chiplet and at second droop detector of a second chiplet. A first voltage droop that triggers a first clock modulation enable signal is detected. The first clock modulation enable signal is communicated from the first chiplet to the second chiplet. A second voltage droop is detected at the second droop detector of the second chiplet, the second voltage droop triggers a second clock modulation enable signal, the second voltage droop is detected after the first voltage droop. The second clock modulation enable signal is communicated to the first chiplet. Using a bypass mode at the first chiplet, the second clock modulation enable signal from the second chiplet is bypassed.

In a third embodiment, a semiconductor system is provided with a shared power supply coupled to two or more chiplets; a first chiplet coupled to a first droop detector, the first chiplet supports a bypass mode comprising a control logic to override clock modulation enable signals from the second chiplet; and a second chiplet coupled to a second droop detector, the second chiplet supports a bypass mode comprising a control logic to override clock modulation enable signals from the second chiplet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a schematic of an exemplary cross section of a 3D-IC with shared power supply between chiplets, in accordance with aspects of the technology described;

FIG. 2 is a schematic of an exemplary motherboard plan for an artificial intelligence hardware system, in accordance with aspects of the technology described herein;

FIG. 3 is a schematic of an exemplary power delivery model for a shared power supply between chiplets, in accordance with aspects of the technology described herein;

FIG. 4 is a schematic of an exemplary clock modulation scheme with a power delivery network, in accordance with aspects of the technology described herein;

FIG. 5 is an exemplary graph of a comparison of different parameters with and without clock modulation, in accordance with aspects of the technology described herein;

FIG. 6 is a schematic of an exemplary clock modulation among 3D-ICs with a shared power supply among two chiplets, in accordance with aspects of the technology described herein;

FIG. 7 is an exemplary graph of a delay in droop detection between chiplets having different impedances, in accordance with aspects of the technology described herein;

FIG. 8 is an exemplary graph of power delivery network impedance profiles of chiplets, in accordance with aspects of the technology described herein;

FIG. 9 is a schematic of an exemplary clock modulation scheme with a single droop detector that drives clock modulation of other chips, in accordance with aspects of the technology described herein;

FIG. 10 provides a first exemplary method of providing power management using a power management engine of a semiconductor system, in accordance with aspects of the technology described herein; and

FIG. 11 provides a second exemplary method of providing power management using a power management engine of a semiconductor system, in accordance with aspects of the technology described herein.

### DETAILED DESCRIPTION

### Overview

A semiconductor system can refer to a 3D integrated circuit package (“3D-IC package”). 3D-IC package is a type of semiconductor packaging technology that enables stacking of multiple integrated (IC) dies or chiplets vertically within a single package. Unlike traditional 2D IC packages where dies are arranged side by side on a substrate, 3D-IC packages allow for compact integration of heterogeneous functional blocks, such as processors, memory, and sensors, by stacking them vertically. This vertical integration is achieved using Through-Silicon Vias (TSVs) or microbumps for inter-die connections, and often involves a silicon interposer or substrate to facilitate routing and connectivity between the stacked dies. 3D-IC packages offer advantages such as reduced footprint, improved performance, increased functionality, and enhanced thermal management, making them ideal for a wide range of applications including high-performance computing, mobile devices, and internet-of-things (IoT) devices.

Conventional power management schemes in semiconductor systems are not configured with logic and infrastructure for efficient dynamic power management for chiplets. For example, power management techniques simply limit voltage droop sensing and clock modulation to a single chiplet. Power management techniques do not include shared clock modulation or shared sensing for droop modulation. In a 3D-IC package having multiple chiplets, chiplets may have varying impedance characteristics, such that differential droop responses can occur due to the disparity in impedance levels. The impedance mismatch results in different voltage droop behaviors among chiplets during transient load conditions. For example, while operating, a first chiplet, from a chiplet set in a semiconductor system, can experience a voltage droop faster than the other chiplets in the chiplet set. In particular, a chiplet with worse impedance will observe higher and quicker droop compared to a chiplet with a better impedance. As such, a power management solution can be developed to account for the worst case droop scenario among chiplets in the chiplet set.

Embodiments of the present technical solution are directed to systems, methods, and computer storage media for, among other things, providing power management using a power management engine of a semiconductor system. Power management can refer to power management techniques associated with a semiconductor component (e.g., chiplet), where the techniques and mechanisms are employed to regulate and optimize power consumption. The power management engine supports monitoring power usage, detecting changes in operating conditions, and dynamically adjusting power-related parameters to meet a chiplet's performance requirements. In particular, the power management engine supports asynchronous voltage droop detection among chiplets in an integrated circuit, where asynchronous detection denotes that droop events are detected at different times or rates by individual chiplets, without being synchronized or aligned with each other.

At a high level, the power management technical solution uses a droop detect of one chiplet to control clock modulation on another chiplet of an integrated circuit package. In particular, the integrated circuit includes multiple chiplets with corresponding droop detectors, and a droop detector with superior performance metrics (e.g., response time, noise filtering, error margins) can be identified. By way of illustration, a semiconductor system (e.g., a 3D-IC package) can include a first chiplet and a second chiplet that share a power supply, and corresponding droop detectors that independently monitor voltages levels associated with the power supply. Each chiplet can further be independently coupled to other power management components (e.g., Phased-Locked Loop (PLL), frequency divider, and clock modulation unit). An event (e.g., di/dt event) at one of the chiplets can induce a voltage droop at another chiplet. The first chiplet is identified as the chiplet that detected the voltage droop. If the voltage droop triggers a clock modulation (e.g., a voltage level that crosses a voltage limit), a clock modulation signal (e.g., a clock modulation enable signal) is communicated to the start clock modulation in the second chiplet. Moreover, if there are more than two chiplets, the signal is communicated to all other chiplets. The second chiplet may also detect the voltage droop and generate a second clock modulation enable signal; however, bypass modes exist at each of the chiplets to support bypassing the second clock modulation enable signal.

Advantageously, the embodiments of the present technical solution include several inventive features (e.g., operations, chiplets, droop detectors) associated with a semiconductor system. The power management engine of the semiconductor system includes multiple chiplets having corresponding droop detectors; however, only one droop detector is used for controlling clock modulation for the chiplets. As such, the power management engine and power management resources can identify a droop detector with superior performance metrics (e.g., response time, noise filtering, error margins) so that the identified droop detector is used to send clock modulation enable signals for chiplets in the semiconductor system.

### Example Systems and Resources

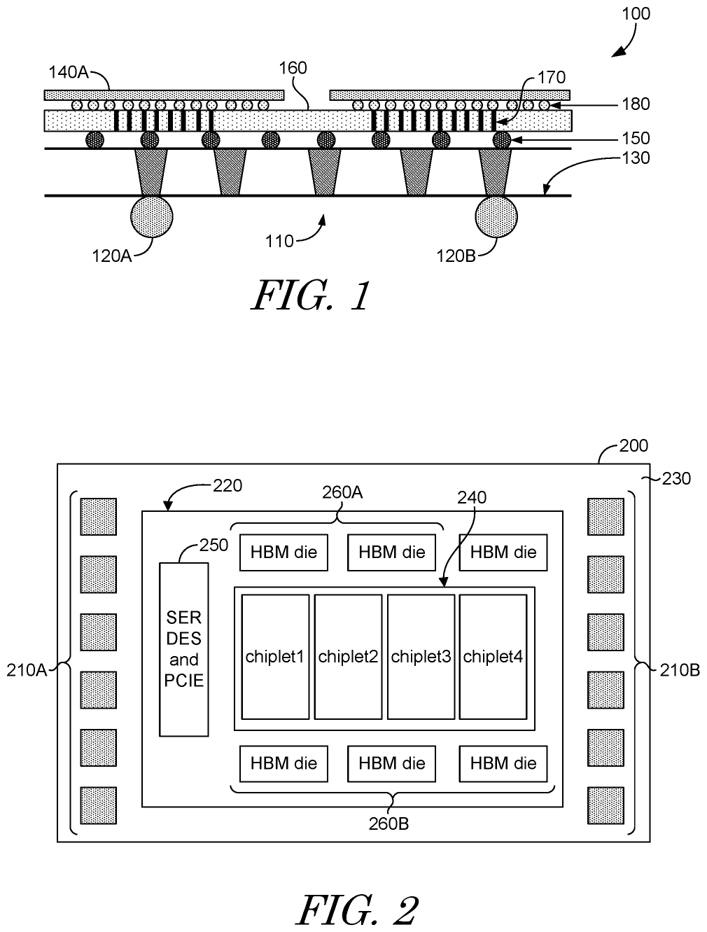

Aspects of the technical solution can be described by way of examples and with reference to FIGS. 1-8.

With reference to FIG. 1, FIG. 1 illustrates a cross-section of a 3D-IC package 100 featuring a shared chiplet power supply. FIG. 1 depicts power delivery network (PDN) 110 in 3D-IC package 100, the PDN 110 connects the internal components to the external power supply through BGA (Ball Grid Array) balls. These BGA balls (BGA 120A and BGA 120B) are soldered to the package substrate and serve as electrical connections between the package and the printed circuit board (PCB) or substrate on which it is mounted. The package plane 130, typically a substrate or interposer within the package structure, is also interconnected with the BGA balls. The PDN 100 extends from the BGA balls to the chiplet (chiplet 140A and chiplet 140B) dies. Current traverses through the package plane 130, proceeding through C4 bumps (C4 bumps 150) to the bottom die 160, then through Through-Silicon Vias (TSVs) 170, ultimately reaching the chiplets via micro bumps (ubumps 180) positioned between chiplet 140A and chiplet 140B and the bottom die 160. Notably, the bottom die 160 may function as a passive interposer. Chiplet 140A and chiplet 140B can be identical dies typically situated adjacent to each other atop the bottom die 160 or interposer die, are also depicted.

Power management in chiplets involves the implementation of strategies to efficiently regulate and distribute electrical power within individual chiplets and across the chiplet ensemble within a larger integrated circuit or system. This includes dynamic voltage regulation to ensure stable supply voltages, clock modulation techniques to adjust operating frequencies based on workload demands, and sophisticated power gating mechanisms to selectively power down or scale back inactive or low-power components. Additionally, chiplets may incorporate droop detection and mitigation mechanisms to address transient voltage droop events, as well as advanced thermal management techniques to manage heat dissipation and ensure reliable operation under varying operating conditions. Overall, power management in chiplets aims to optimize energy efficiency, maximize performance, and enhance reliability while minimizing power consumption and thermal concerns.

In a heterogeneous chiplet-based system, variations in silicon manufacturing and design complexities can manifest as functional discrepancies or failures in critical components such as droop detectors. For example, a droop detector located on a chiplet may have suboptimal functioning or functionality failure due to silicon variation or silicon manufacturing defects. Chiplets may exhibit diverse silicon behaviors owing to manufacturing variations. One chiplet may demonstrate superior margin of error in detecting voltage droops compared to another. Alternatively, a chiplet might suffer from suboptimal droop detection functionality due to local noise interference.

With reference to FIG. 2, the motherboard layout 200 for an artificial intelligence hardware system features key components such as Voltage Regulator Modules (VRMs)—left VMRs 210B and right VMRs 210B and a package 220 soldered to the board 230. Within the package 220, components include the bottom die 240, chiplets (numbered 1 to 4), SerDes (IO) die 250, and High Bandwidth Memory (HBM) memory dies-top HBM dies 260A and bottom HBM dies 260B. Connection to the board is facilitated by BGA (Ball Grid Array) balls. VRMs situated on the motherboard provide power to the chiplets, with each supply type potentially supported by one or more VRMs.

The placement of voltage regulators on the motherboard, as well as the routing of power supply traces at both the board and package levels, can result in variations in the PDN by individual chiplets within a heterogeneous chiplet-based system. Variations in PDN impedance between chiplets can lead to asynchronous detection of voltage droop events. In such instances, one chiplet may detect a droop and initiate clock frequency modulation to compensate, while another chiplet, with higher impedance, continues to operate at elevated frequencies, exacerbating the droop before detecting it internally. Insufficient guard banding to account for these disparities in droop detection can result in functional failures. Implementing additional voltage guard banding incurs an extra power cost to ensure reliable operation. In severe cases, droop detectors may malfunction entirely due to silicon manufacturing defects. These discrepancies can result in asynchronous droop detection and clock modulation among chiplets sharing a power supply, hindering the effectiveness of the overall droop mitigation scheme.

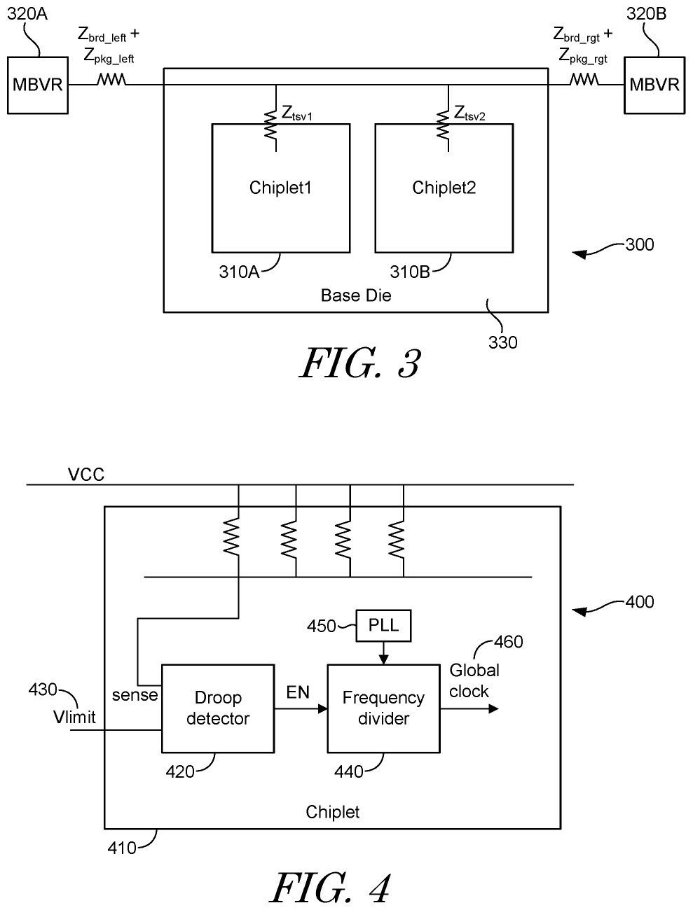

With reference to FIG. 3, FIG. 3 illustrates schematic of the PDN 300 originating from the motherboard voltage regulators (MBVR) and extending to the chiplets—chiplet1 310A and chiplet1 310B (with consideration for only two chiplets in this instance). Assuming the MBVR phases are positioned on the right side-associated with MBVR 320A—and left side—associated with MBVR 320B of the 3D-IC, the PDN impedance from the left side of the board and package is denoted as Z_{brd_left} and Z_{pkg_left}, respectively. Similarly, the PDN impedance from the right side of the board and package is denoted as Z_{brd_rgt} and Z_{pkg_rgt}, respectively. Notably, Z_{brd_left} and Z_{brd_rgt} may differ due to non-identical PDN implementation on the board. Likewise, Z_{pkg_ret} is also distinct from Z_{pkg_left}. Zₜₛᵥ₁ represents the effective TSV impedance connecting the bottom die to chiplet1 310A, while Zₜₛᵥ₂ denotes the effective TSV impedance connecting the bottom die 330 to chiplet2 310B. It is important to note that Zₜₛᵥ₁ and Zₜₛᵥ₂ may not be equivalent.

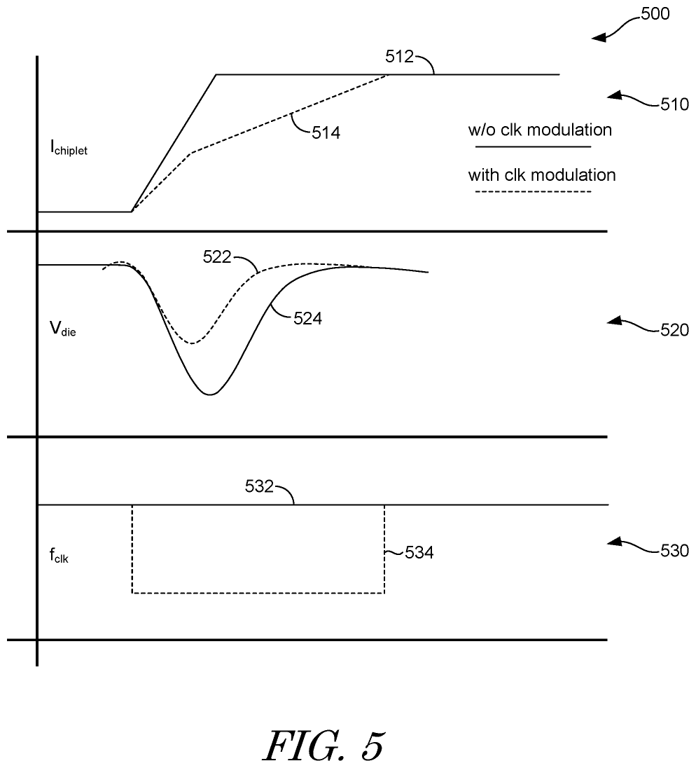

With reference to FIG. 4, FIG. 4 illustrates a clock modulation scheme 400 to mitigate voltage droop. Clock modulation serves as a technique to address voltage droop in the event of dynamic current change occurrences (e.g., di/dt). Failure to mitigate voltage droop necessitates guard banding, resulting in heightened power consumption. Guard banding provides a safety margin or buffer to account for uncertainties, variations, or unexpected conditions in voltage. A typical voltage on the PDN network (Vdie) can be monitored by a droop detector 420 of chiplet 410, which also receives a voltage threshold (Vlimit) 430 as input. Should Vdie fall below Vlimit 430, the droop detector 420 activates a frequency divider 440 block 440, thereby reducing the clock frequency by a factor (e.g., 2, 3, or more). The chiplet is operationally coupled to PLL 450, and communicatively coupled to a global clock via global clock communication path 460.

By way of illustration, a chiplet utilizes a clock modulation enable signal to dynamically adjust its internal (e.g., via a global clock communication a path) clock frequency in response to voltage droop events or power management directives. Upon detection of a voltage droop or receipt of a power management directive, the chiplet generates a clock modulation enable signal, activating its internal clock modulation mechanism (e.g., clock modulation unit—not shown). This mechanism adjusts the chiplet's operational frequency, typically by reducing the frequency of internal clock signals, in order to mitigate the effects of the droop or meet power constraints.

Throughout this process, the chiplet continuously monitors system conditions and may provide feedback to the system controller regarding the effectiveness of the clock modulation. Once the voltage droop event subsides or the power management objectives are achieved, the chiplet deactivates the clock modulation mechanism by disabling the clock modulation enable signal, returning to its normal operating frequency. This adaptive clock modulation approach ensures efficient operation and reliable performance of the chiplet in varying system conditions.

With reference to FIG. 5, FIG. 5 illustrates graphs 500 showing a comparison of different parameters with and without clock modulation. The graphs include die current di/dt events 510, voltage droop 520, and clock frequency plots 530, both with and without clock modulation. Notably, the voltage droop observed with clock modulation is especially lower compared to the voltage droop experienced without clock modulation. This highlights the effectiveness of clock modulation in mitigating voltage droop under varying current di/dt conditions. By way of illustration, graph levels (e.g., 512, 522, and 532) depicting parameters associated with voltage droop without clock modulation, are based on the voltage level initially remains stable. As a sudden increase in current demand occurs, the voltage would begin to drop rapidly and linearly over time. In contrast, graph levels (e.g., 515, 524, and 534) depicting parameters associated with droop with clock modulation are based on the voltage droop curve exhibiting a more gradual and controlled decrease in voltage level compared to the scenario without clock modulation. When a di/dt event occurs, triggering the droop detector, clock modulation would be initiated to reduce the clock frequency of the system. This reduction in clock frequency leads to a decrease in the rate of current consumption, thereby mitigating the voltage droop. As a result, the voltage droop curve with clock modulation shows a shallower slope and potentially a smaller decrease in voltage level compared to the scenario without clock modulation. The duration of the droop is also be shorter due to the faster response of the clock modulation mechanism.

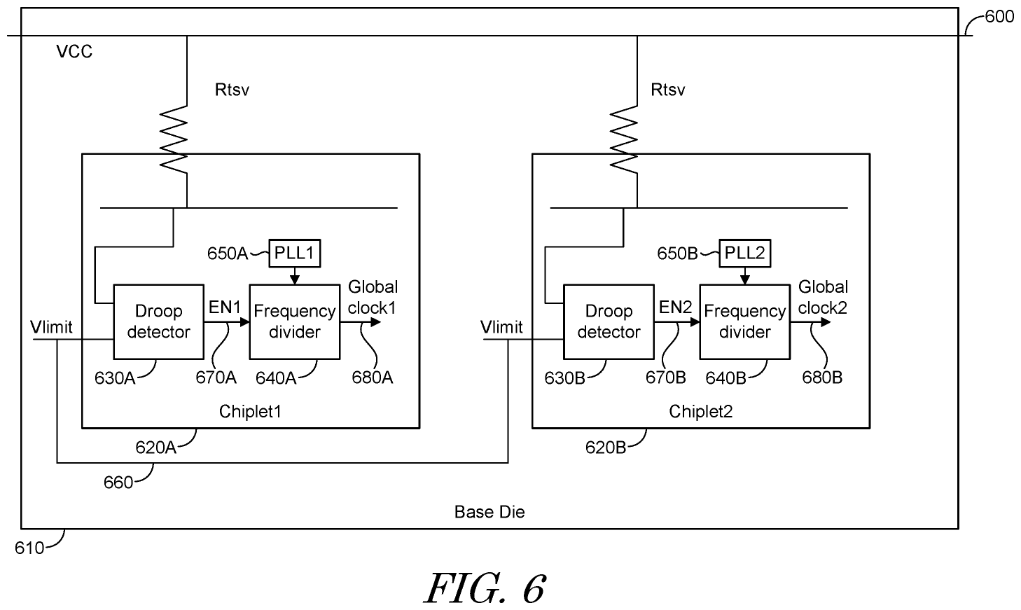

With reference to FIG. 6, FIG. 6 illustrates the typical clock modulation scheme employed in 3D Integrated Circuits (3DICs). In this scheme, the power supply (VCC) 600 is shared among the chiplets (chiplet 620A and chiplet 620B), with each chiplet having its dedicated Phase-Locked Loop (PLL) (PLL1 650A and PLL2 650B), voltage droop detector (droop detector 630A and droop detector 630), frequency divider (frequency divider 640A and frequency divider 640B), signal path (EN1 670A, and EN2 670B), global clock path (global clock1 680A and global clock2 680B). Notably, the droop detector threshold, Vlimit (Vlimit 660), is shared among all chiplets. While it is possible to assign different droop detector thresholds (e.g., Vlimit1 and Vlimit2) to each droop detector, doing so would necessitate post-silicon calibration overhead. Hence, a single Vlimit is commonly utilized across all chiplets for practicality and efficiency.

Several potential problems exist when each chiplet has a dedicated droop detector including silicon variation, local power supply noise, and PDN impedance. For silicon variation, due to inherent variations in silicon process technology, transistors within a chiplet die may operate at different speeds. This can lead to slower response times of the droop detector IP or a loss of resolution, resulting in delayed triggering of clock modulation and potentially increasing the voltage guard band. Additionally, silicon variation can increase the error margin of the droop detector, causing it to flag output signals at slightly different voltages than the set threshold due to variations in manufacturing processes.

Various factors can contribute to local power supply noise within a chiplet. For instance, high-speed IO operations (such as SerDes, PCIE, or HBM) may generate switching noise that couples more significantly to one chiplet compared to others. Moreover, at the server blade level where multiple AI motherboards are interconnected, system-level noise coupling from other components can occur. This noise can impair the optimal functioning of a droop detector, especially if it is an analog IP, potentially leading to unnecessary triggering of the droop detector.

As illustrated in FIG. 2 and FIG. 3, the PDN impedance observed by each chiplet can vary due to asymmetry in metal routing. For example, Chiplet1 may experience a peak impedance (Z1) of mohms at frequency (f1) MHz, while Chiplet2 may encounter a peak impedance (Z2) at a different frequency (f2) MHz, with Z1<Z2 and f1<f2. During a di/dt event, the voltage at Chiplet2 may droop faster and to a greater extent than at Chiplet1. Consequently, when Chiplet2 detects droop earlier, it initiates clock modulation, while Chiplet1 is yet to experience the droop. This delay in clock modulation hinders droop recovery, leading to prolonged voltage droop.

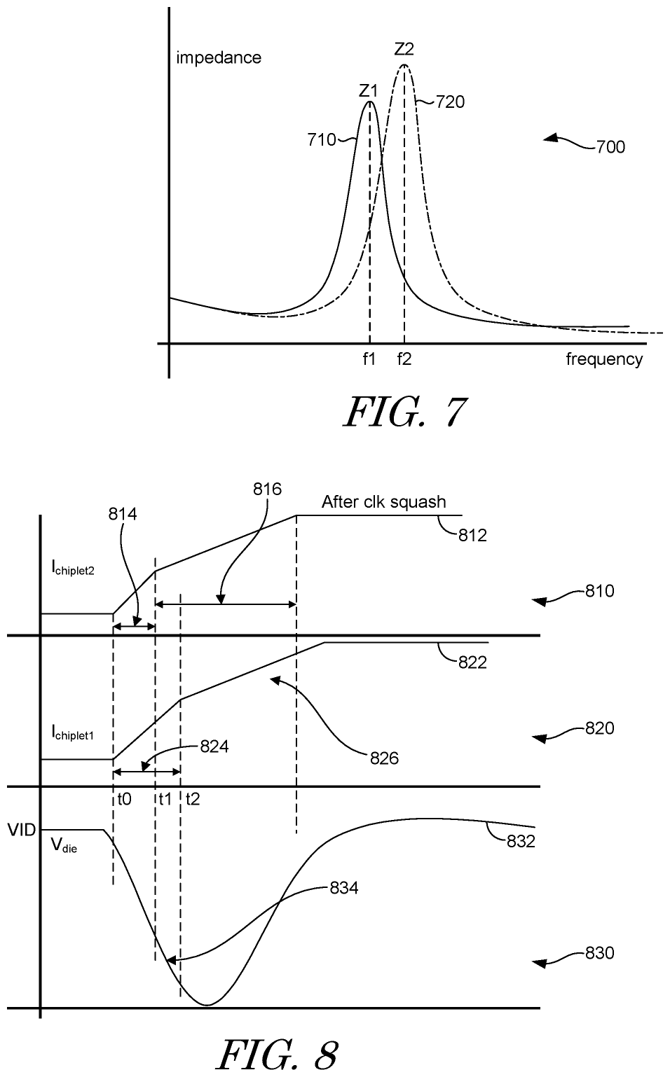

With reference to FIG. 7 and FIG. 8, when a second chiplet detects droop, initiating clock modulation due to the faster voltage droop, the first chiplet remains unaware of the voltage droop and continues operating at a high frequency. Chiplet1 710 and Chiplet2 720 experience different impedance levels (Z1 and Z2) and frequencies (f1 and f2) due to variations in the power delivery network (PDN). During a di/dt event, Chiplet2 may experience a faster and more significant voltage droop compared to Chiplet1 due to its higher impedance and/or frequency. As a result, Chiplet2 detects the droop earlier and initiates clock modulation to mitigate the voltage droop. However, Chiplet1, which has not yet experienced the droop, continues to operate at its normal frequency without initiating clock modulation. This delay in clock modulation by Chiplet1 hinders the recovery from the voltage droop, leading to a prolonged period of decreased voltage. Overall, the asymmetry in impedance and frequency among chiplets can result in differential responses to voltage droop events, potentially prolonging the recovery process and affecting the overall performance of the system. In this way, this discrepancy impedes droop recovery, as illustrated in FIG. 7.

Chiplet2 commences clock modulation at time t1, resulting in a reduction in its di/dt, while chiplet 1 maintains the same di/dt rate. Subsequently, chiplet 1 begins clock modulation at time t2, reducing its di/dt rate. Consequently, the combined di/dt of Chiplet1 and Chiplet2 decreases only after time t2. During the interval between t1 and t2, the voltage continues to droop, as depicted in FIG. 8.

By way of illustration, during the onset of a di/dt event, Chiplet2 810 promptly responds by initiating clock modulation at time t1 814, effectively reducing its rate of change of current (di/dt) and mitigating the voltage droop experienced 816. This action results in a stabilization of Chiplet2's power consumption and aids in preventing further exacerbation of the droop. However, Chiplet1 820, having not yet detected the droop, maintains its original di/dt rate during this initial phase. It is only after time t2 824 that Chiplet1 also engages clock modulation, subsequently reducing its di/dt rate, without adequately mitigating the voltage droop experience 826. As a consequence, the combined di/dt of Chiplet1 and Chiplet2 begins to decrease only after time t2. Meanwhile, during the time interval between t1 and t2, while Chiplet 2 is actively mitigating the droop, Chiplet1 continues to operate at its standard di/dt rate, contributing to the prolonged presence of the voltage droop. This delay in clock modulation by Chiplet1 extends the duration of the recovery process, allowing the voltage droop to persist until both chiplets have successfully adjusted their di/dt rates.

With regard to voltage 830, even after Chiplet2 initiates clock modulation (also known as “clk squashing”), effectively reducing its rate of current change (di/dt) and mitigating the voltage droop 832, the droop continues unabated 834. It is only when Chiplet1 also begins its clock modulation that the voltage droop begins to recover. This indicates that the droop persists during the period when only Chiplet 2 is actively mitigating it. The recovery of the voltage droop is observed only after both Chiplet1 and Chiplet2 are engaged in clock modulation. The droop mitigation efforts of Chiplet2 alone are insufficient to fully address the voltage droop, and it requires the combined action of both chiplets to effectively stabilize the voltage level.

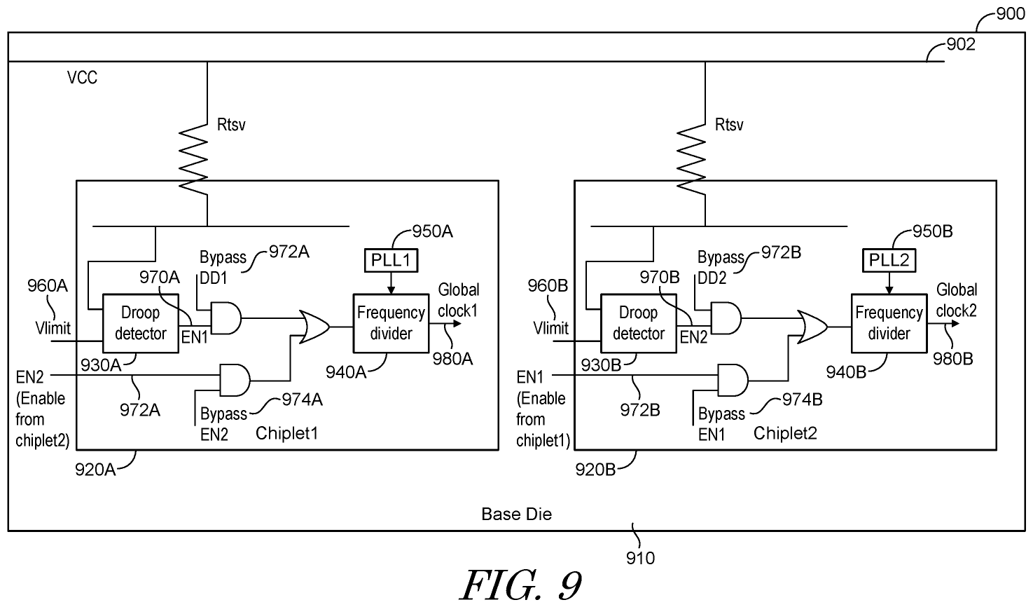

With reference to FIG. 9, FIG. 9 illustrates a power management scheme where a single droop detector drives clock modulation of other chiplets. The power management scheme is associated with semiconductor system 900 with a power management engine including base die 910, Chiplet1 920A, Chiplet2 920B, droop detector 930A, droop detector 930B, frequency divider 940A, frequency divider 940B, PLL1 950A, PLL2 950B, Vlimit 960A, Vlimit 960B, EN1 970A, EN2 970B, bypass DD1 972A, bypass DD2 972B, bypass EN2 974A, and bypass EN1 974B. In this way, the technical solution is illustrated with reference to a 3D-IC that uses a droop detector of one chiplet to control clock modulation on another chiplet of the 3D-IC package. In particular, in a 3D-IC with multiple chiplets having corresponding droop detectors, a droop detector with superior performance metrics (e.g., response time, noise filtering, error margins) can be identified- and employed to send clock modulation enable signals.

By way of illustration, a semiconductor system (e.g., a 3D-IC package) can include a first chiplet (e.g., Chiplet 920A) and a second chiplet (e.g., Chiplet 920B) that share a power supply (e.g., VCC 902). Each chiplet can further be independently coupled to other power management components (e.g., Phased-Locked Loop (PLL), frequency divider, and clock modulation unit). An event (e.g., di/dt event) at one of the chiplets can induce a voltage droop at another chiplet.

The Chiplet 920A is identified as the chiplet that detected the voltage droop. If the voltage droop triggers a clock modulation (e.g., a voltage level that cross a voltage limit), a clock modulation enable signal is communicated to the start clock modulation in the second chiplet. Moreover, if there are more than two chiplets, the signal is communicated to all other chiplets. Chiplet 920B may also detect the voltage droop and generate a second clock modulation enable signal; however, bypass modes (e.g., bypass EN2 974A and bypass EN1 974B) exist at each of the chiplets to bypass the second clock modulation signal. Bypass modes include a control logic to override a clock modulation enable signal, where overriding a clock modulation enable signal can refer to selectively overriding, discarding, or ignoring the clock modulation enable signal. In other words, the clock modulation enable signal is not used to control a corresponding clock modulation unit of the chiplet.

The propagation delay of the clock modulation enable signal from one chiplet to another for an AI product ideally should be less than few nanoseconds. This can be ensured by implementing large Input/Output driver at the sending end and routing the signal with metal layers which provide lowest resistance and capacitance inside the chiplets and the bottom die (or interposer).

### Example Methods

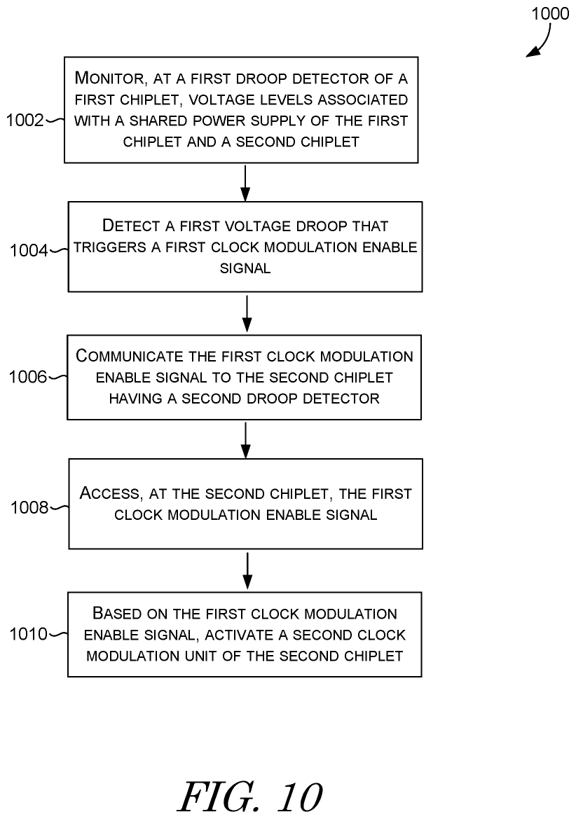

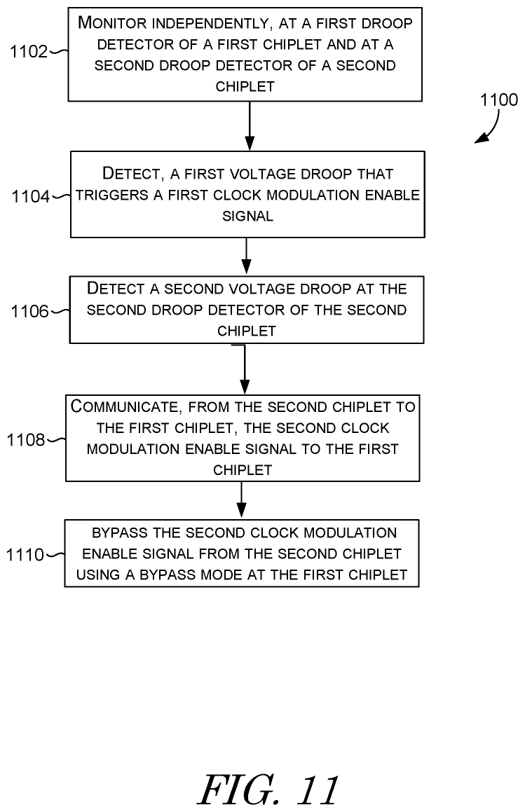

With reference to FIGS. 10 and 11, flow diagrams are provided illustrating methods for providing power management using a power management engine of a semiconductor system. The methods may be performed using the semiconductor system described herein. In embodiments, one or more computer-storage media having computer-executable or computer-useable instructions embodied thereon that, when executed, by one or more processors can cause the one or more processors to perform the methods (e.g., computer-implemented method) in the semiconductor system (e.g., a computerized system).

Turning to FIG. 10, a flow diagram is provided that illustrates a method 1000 for providing power management using a power management engine in a semiconductor system. At block 1002, monitor, at a first droop detector of a first chiplet, voltage levels associated with a shared power supply of the first chiplet and a second chiplet. At block 1004, detect a first voltage droop that triggers a first clock modulation enable signal. At block 1006, communicate the first clock modulation enable signal to the second chiplet having a second droop detector. At block 1008, access, at the second chiplet, the first clock modulation enable signal. At block 1010, based on the first clock modulation enable signal, activate a second clock modulation unit of the second chiplet.

Turning to FIG. 11, a flow diagram is provided that illustrates a method 1100 for providing power management using a power management engine in a semiconductor system. At block 1102, independently monitor, at a first droop detector of a first chiplet and a second droop detector of a second chiplet. At block 1104, detect, a first voltage droop triggers at a first clock modulation enable signal. At block 1106, detect a second voltage droop at the second droop detector of the second chiplet. At block 1108, communicate, from the second chiplet to the first chiplet, the second clock modulation enable signal to the first chiplet. At block 1110, bypass the second clock modulation enable signal from the second chiplet using a bypass mode at the first chiplet.

### Literal Support for Claim Embodiments

In some embodiments, a method is provided. The method comprises: monitoring, at a first droop detector of a first chiplet, voltage levels associated with a shared power supply of the first chiplet and a second chiplet; detecting, a first voltage droop that triggers a first clock modulation enable signal; communicating the first clock modulation enable signal to the second chiplet having a second droop detector; accessing, at the second chiplet, the first clock modulation enable signal; and based on the first clock modulation enable signal, activating a second clock modulation unit of the second chiplet.

In any combination of the above embodiments of the method, the method further comprises: detecting a second voltage droop at the second droop detector of the second chiplet, the second voltage droop triggers a second clock modulation enable signal, wherein the second voltage droop is detected after the first voltage droop; communicating the clock modulation enable signal to the first chiplet; and using a bypass mode at the first chiplet, bypassing the second clock modulation enable signal from the second chiplet.

In any combination of the above embodiments of the method, the first clock modulation enable signal is communicated to a first frequency divider of the first chiplet and a second frequency divider of the second chiplet.

In any combination of the above embodiments of the method, the first chiplet supports a bypass mode comprising a control logic to override clock modulation enable signals from the second chiplet.

In any combination of the above embodiments of the method, the second chiplet supports a bypass mode comprising a control logic to override clock modulation enable signals from the first chiplet.

In any combination of the above embodiments of the method, the first chiplet supports a bypass mode comprising a control logic to override droop detector signals from the first droop detector.

In any combination of the above embodiments of the method, the second chiplet supports a bypass mode comprising a control logic to override droop detector signals from the second droop detector.

In any combination of the above embodiments of the method, the first chiplet is coupled to a first Phased-Locked Loop (PLL) and a first clock modulation unit, and the second chiplet is coupled to a second PLL and the second clock modulation unit.

In any combination of the above embodiments of the method, the method further comprising: based on the first clock modulation enable signal, activating a first clock modulation unit of the first chiplet.

In some embodiments, a method is provided. The method comprises: monitoring, at a first droop detector of a first chiplet and at second droop detector of a second chiplet, voltage levels associated with a shared power supply of the first chiplet and a second chiplet; detecting, a first voltage droop that triggers a first clock modulation enable signal; communicating, from the first chiplet to the second chiplet, the first clock modulation enable signal; detecting a second voltage droop at the second droop detector of the second chiplet, the second voltage droops triggers a second clock modulation enable signal, wherein the second voltage droop is detected after the first voltage droop; communicating, from the second chiplet to the first chiplet, the second clock modulation enable signal to the first chiplet; and using a bypass mode at the first chiplet, bypass the second clock modulation enable signal from the second chiplet.

In any combination of the above embodiments of the method, the method further comprising: accessing, at the second chiplet, the first clock modulation enable signal; and based on the first clock modulation enable, activating a second clock modulation unit of the second chiplet.

In any combination of the above embodiments of the method, the method further comprising: the first clock modulation enable signal is communicated to a first frequency divider of the first chiplet, and a second frequency divider of the second chiplet, and the first chiplet is coupled to a first Phased-Locked Loop (PLL) and a first clock modulation unit, and the second chiplet is coupled to a second PLL and a second clock modulation unit.

In any combination of the above embodiments of the method, the clock modulation enable signals are triggered based on detecting voltage levels that cross a threshold limit.

In any combination of the above embodiments of the method, communicating the clock modulation enable signals across chiplets is based on an Input/Output driver that routes a clock modulation enable signal with metal layers that provide reduced resistance and capacitance inside chiplets and a bottom die of an integrated circuit.

In some embodiments, a semiconductor system is provided. The semiconductor system comprises a shared power supply coupled to two or more chiplets; a first chiplet coupled to a first droop detector, the first chiplet supports a bypass mode comprising a control logic to override clock modulation enable signals from the second chiplet; and a second chiplet coupled to a second droop detector, the second chiplet support a bypass mode comprising a control logic to override clock modulation enable signals from the second chiplet.

In any combination of the above embodiments of the system, wherein the second droop detector of the second chiplet is disabled and the clock modulation enable signal from the first chiplet is used for clock modulation on the second chiplet.

In any combination of the above embodiments of the system, wherein the first chiplet supports a bypass mode comprising a control logic to override droop detector signals from the first droop detector.

In any combination of the above embodiments of the system, wherein the second chiplet supports a bypass mode comprising a control logic to override droop detector signals from the second droop detector.

In any combination of the above embodiments of the system, the first chiplet is configured to: monitor, at the first droop detector of the first chiplet, voltage levels associated with the shared power supply of the first chiplet and the second chiplet; detect a first voltage droop that triggers a first clock modulation enable signal; and communicate the first clock modulation enable signal to a second chiplet having a second droop detector to cause activation of a second clock modulation unit of the second chiplet.

In any combination of the above embodiments of the system, the second chiplet is configured to: monitor, at the second droop detector of the second chiplet, voltage levels associated with the shared power supply of the first chiplet and the second chiplet; detect a second voltage droop at the second droop detector of the second chiplet, the second voltage droops triggers a second clock modulation enable signal, wherein the second voltage droop is detected after the first voltage droop; and communicate the second clock modulation enable signal to the first chiplet, wherein the first chiplet using a bypass mode, bypasses the second clock modulation enable signal.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A method, the method comprising:
monitoring, at a first droop detector of a first chiplet, voltage levels associated with a shared power supply of the first chiplet and a second chiplet;
detecting, a first voltage droop that triggers a first clock modulation enable signal;
communicating the first clock modulation enable signal to the second chiplet having a second droop detector;
accessing, at the second chiplet, the first clock modulation enable signal; and
based on the first clock modulation enable signal, activating a second clock modulation unit of the second chiplet.

2. The method of claim 1, the method further comprising:
detecting a second voltage droop at the second droop detector of the second chiplet, the second voltage droop triggers a second clock modulation enable signal, wherein the second voltage droop is detected after the first voltage droop;
communicating the clock modulation enable signal to the first chiplet; and
using a bypass mode at the first chiplet, bypassing the second clock modulation enable signal from the second chiplet.

3. The method of claim 1, wherein the first clock modulation enable signal is communicated to a first frequency divider of the first chiplet and a second frequency divider of the second chiplet.

4. The method of claim 1, wherein the first chiplet supports a bypass mode comprising a control logic to override clock modulation enable signals from the second chiplet.

5. The method of claim 1, wherein the second chiplet supports a bypass mode comprising a control logic to override clock modulation enable signals from the first chiplet.

6. The method of claim 1, wherein the first chiplet supports a bypass mode comprising a control logic to override droop detector signals from the first droop detector.

7. The method of claim 1, wherein the second chiplet supports a bypass mode comprising a control logic to override droop detector signals from the second droop detector.

8. The method of claim 1, wherein the first chiplet is coupled to a first Phased-Locked Loop (PLL) and a first clock modulation unit, and the second chiplet is coupled to a second PLL and the second clock modulation unit.

9. The method of claim 1, the method further comprising: based on the first clock modulation enable signal, activating a first clock modulation unit of the first chiplet.

10. A method, the method comprising:
monitoring, at a first droop detector of a first chiplet and at second droop detector of a second chiplet, voltage levels associated with a shared power supply of the first chiplet and a second chiplet;
detecting, a first voltage droop that triggers a first clock modulation enable signal;
communicating, from the first chiplet to the second chiplet, the first clock modulation enable signal;
detecting a second voltage droop at the second droop detector of the second chiplet, the second voltage droops triggers a second clock modulation enable signal, wherein the second voltage droop is detected after the first voltage droop;
communicating, from the second chiplet to the first chiplet, the second clock modulation enable signal to the first chiplet; and
using a bypass mode at the first chiplet, bypass the second clock modulation enable signal from the second chiplet.

11. The method of claim 10, the method further comprising:
accessing, at the second chiplet, the first clock modulation enable signal; and
based on the first clock modulation enable, activating a second clock modulation unit of the second chiplet.

12. The method of claim 10, wherein the first clock modulation enable signal is communicated to a first frequency divider of the first chiplet, and a second frequency divider of the second chiplet, and
wherein the first chiplet is coupled to a first Phased-Locked Loop (PLL) and a first clock modulation unit, and the second chiplet is coupled to a second PLL and a second clock modulation unit.

13. The method of claim 10, wherein the clock modulation enable signals are triggered based on detecting voltage levels that cross a threshold limit.

14. The method of claim 10, wherein communicating the clock modulation enable signals across chiplets is based on an Input/Output driver that routes a clock modulation enable signal with metal layers that provide reduced resistance and capacitance inside chiplets and a bottom die of an integrated circuit.

15. A semiconductor system comprising:
a shared power supply coupled to two or more chiplets;
a first chiplet coupled to a first droop detector, the first chiplet supports a bypass mode comprising a control logic to override clock modulation enable signals from the second chiplet; and
a second chiplet coupled to a second droop detector, the second chiplet support a bypass mode comprising a control logic to override clock modulation enable signals from the second chiplet.

16. The system of claim 15, wherein the second droop detector of the second chiplet is disabled and the clock modulation enable signal from the first chiplet is used for clock modulation on the second chiplet.

17. The system of claim 15, wherein the first chiplet supports a bypass mode comprising a control logic to override droop detector signals from the first droop detector.

18. The system of claim 15, wherein the second chiplet supports a bypass mode comprising a control logic to override droop detector signals from the second droop detector.

19. The system of claim 15, wherein the first chiplet is configured to:
monitor, at the first droop detector of the first chiplet, voltage levels associated with the shared power supply of the first chiplet and the second chiplet;
detect a first voltage droop that triggers a first clock modulation enable signal; and
communicate the first clock modulation enable signal to a second chiplet having a second droop detector to cause activation of a second clock modulation unit of the second chiplet.

20. The system of claim 19, wherein the second chiplet is configured to:
monitor, at the second droop detector of the second chiplet, voltage levels associated with the shared power supply of the first chiplet and the second chiplet;
detect a second voltage droop at the second droop detector of the second chiplet, the second voltage droops triggers a second clock modulation enable signal, wherein the second voltage droop is detected after the first voltage droop; and
communicate the second clock modulation enable signal to the first chiplet, wherein the first chiplet using a bypass mode, bypasses the second clock modulation enable signal.
